(19) United States
(12) Patent Application Publication
(10) Pub. No.: US 2006/0226666 A1
(43) Pub. Date: Oct. 12, 2006

(54) Autoclavable vacuum lifter

(76) Inventors: Kishor N. Chavda, Charlottesville, VA (US); Randy Lee Good, Elkton, VA (US)

Correspondence Address: MERCK AND CO., INC, P O BOX 2000, RAHWAY, NJ, 07065-0907, US

(21) Appl. No.: 11/260,977

(22) Filed: Oct. 28, 2005

Related U.S. Application Data
(60) Provisional application No. 60/623,680, filed on Oct. 29, 2004.

(51) Int. Cl. B25J 15/06

(52) U.S. Cl. 294/64.1

(57) ABSTRACT

The present invention relates to an apparatus that aids in the transportation of objects having at least one side with a smooth, flat surface. The vacuum lifter is autoclavable and washable by disinfectants routinely used to maintain aseptic compliance in industries such as the pharmaceutical and food industries. In addition the vacuum lifter of the present invention includes a check valve assembly that can be optionally maintained in the open position during the autoclave or disinfection operation.

### FIELD OF THE INVENTION

The present invention relates to an apparatus that aids in the transportation of objects having at least one side with a smooth, flat surface. The vacuum lifter is autoclavable and washable by disinfectants routinely used in the pharmaceutical and food industries.

### BACKGROUND OF THE INVENTION

Currently, commercially available suction (vacuum) lifters typically are constructed of a rubber suction cup affixed to an aluminum handle. The rubber suction-cup is placed on the smooth, flat, non-porous surface of the object to be transferred. Air is evacuated out of the suction cup and the edge of the vacuum cup forms a seal with the surface of the object. The ensuing vacuum grips the surface of the object and holds it, thus allowing the object to be lifted and transferred to a desired location. The vacuum is broken to release the suction lifter from the object. There are many models of suction lifters commercially available such as those offered by Allstates Rubber & Tool, Inc. (Tinly Park, Ill.) and All-Vac Industries, Inc. (Skokie, Ill.).

In industries with very high hygienic demands, such as the food, biotech, semiconductor, aerospace, and pharmaceutical industries, it is desirable to minimize contamination of products, product packaging or manufacturing equipment with bacteria and foreign particulates. One way to minimize surface contamination is to physically avoid touching the product or product containers during routine transfer operations. This reduces the chance that bacteria, oils, skin, hair and other contaminants will contact the surface. Use of suction lifters would aid in this endeavor because a vacuum lifter could be employed without physically touching the surface of the object to be transferred.

Additionally, because of the stringent hygiene standards required industries such as the pharmaceutical and food industries, it is highly desirable to ensure that any vacuum lifter relied upon can be treated to maintain aseptic compliance. Typically, this means that the vacuum lifter selected must be able to withstand standard disinfection protocols (cleaning with a series of highly caustic and acidic washes) as well as high temperature exposures found in the sterilization process using an autoclave.

The currently available vacuum lifters found in the market today, do not hold up well to the standard disinfection/autoclave protocols previously mention. Particularly, vacuum lifters having aluminum parts have the disadvantage that the aluminum oxidizes readily and generates a black surface that flakes off after a few weeks of use when exposed to the standard aseptic compliance protocols. The foreign particulates that flake off may contribute to the contamination of the final product. To address this problem, the vacuum lifter of the present invention is manufactured from Federal Drug Agency (FDA) approved materials that can withstand the harsh disinfection procedures required. The vacuum lifter of the present invention has also been designed to make the autoclave process easy.

### SUMMARY OF THE INVENTION

The present invention relates to an apparatus that aids in the transportation of objects having at least one side with a smooth, flat surface. The vacuum lifter is autoclavable and washable by disinfectants routinely used in the pharmaceutical and food industries. The vacuum lifter of the present invention is manufactured from Federal Drug Agency (FDA) approved materials that can withstand the harsh disinfection procedures required. In addition the vacuum lifter of the present invention includes a check valve assembly that can be optionally maintained in the open position during the autoclave or disinfection operation.

The vacuum lifter of the present invention comprises
a) a suction cup having a hub and an axial bleed hole in the hub,
b) a center-piece sleeve member molded in the hub and having threaded extensions above the and forming a continuation of the axial bleed hole,
c) a handle over the cup and above the center-piece sleeve member,
d) a lock-nut, threaded on the center-piece sleeve member and securing the handle to the cup and forming a chamber between the lock-nut and the sleeve member,
e) a means to establish communication between the chamber and the atmosphere,
d) a check valve assembly in the chamber between the bleed hole and the means, wherein the check valve assembly is operatively connected to the means and the check valve assembly normally closing the bleed hole and wherein the means is optionally capable of maintaining the check valve assembly and the bleed hole open.

The suction cup end of the vacuum lifter of the present invention is placed on a smooth, flat, non-porous surface. Pressure is applied to the handle of the vacuum lifter to compress the suction cup downward toward the surface thus evacuating the air from the cup and forming a vacuum seal with the surface. When the check valve assembly is in normal operating position, the check valve stops the back flow of air into the cup and helps to maintain the vacuum. Consequently, since the vacuum is sustained, the hold or “grip” on the object is maintained. As a consequence, the lifting power of the vacuum lifter is maintained.

The materials of construction chosen for the vacuum lifter of the present invention are required to withstand stringent disinfection conditions required for aseptic sterilization. Typical disinfection protocols require use of highly caustic solutions such as CIP200, pH 2, and highly acidic solutions such as CIP100, pH 14. In order to minimize microorganism growth, the vacuum lifter must be able to withstand autoclave steam pressures of typically of from about 15-20 psig of steam (approx. 125-130° C.).

During the autoclave procedure, it is desirable to have the check valve assembly open to the atmosphere to allow steam to penetrate the interior portions of the vacuum lifter. As such, the vacuum lifter of the present invention is equipped with a mechanism that locks the check valve assembly in the open position.

### BRIEF DESCRIPTION OF THE FIGURES OF THE DRAWINGS

The above and other objects, features, advantages and technical significance of the present invention will be better understood by reading the following detailed description of preferred embodiments of the invention, when considered in connection with the accompanying drawings, in which:

FIG. 1 is an oblique view of the vacuum lifter.

FIG. 2 shows the top and side view of the silicon cup.

FIG. 3 shows the placement of the threaded center piece in the silicon cup.

FIG. 4 depicts the assembly of the various elements of the vacuum lifter.

FIG. 5 depicts a vertical sectional view of the lock nut.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a”, “an,” and “the” can mean one or more, depending upon the context in which it is used. The preferred embodiment is described with reference to the figures, in which like numbers indicate like parts throughout the figures.

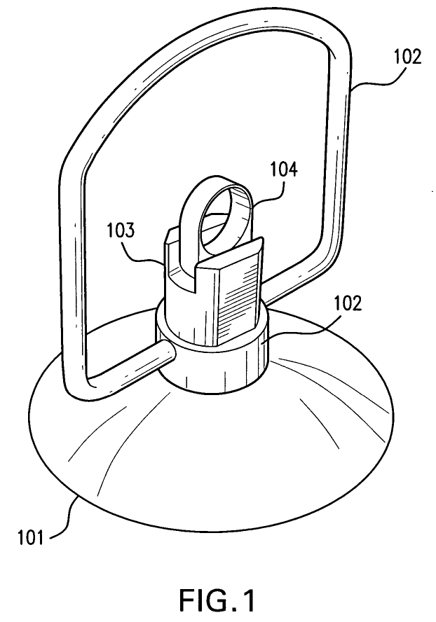

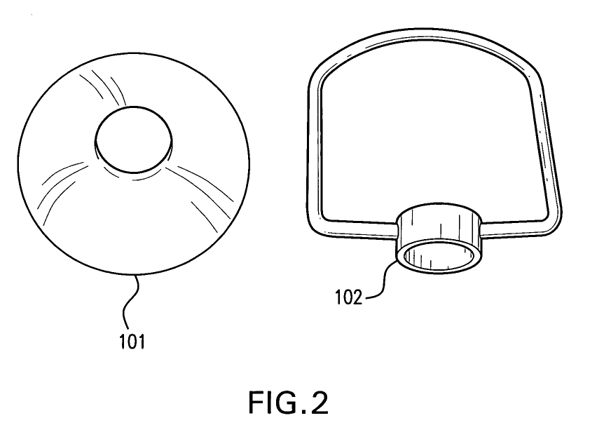

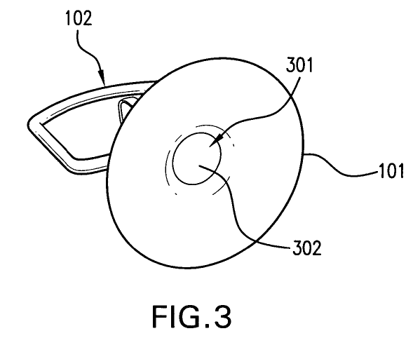

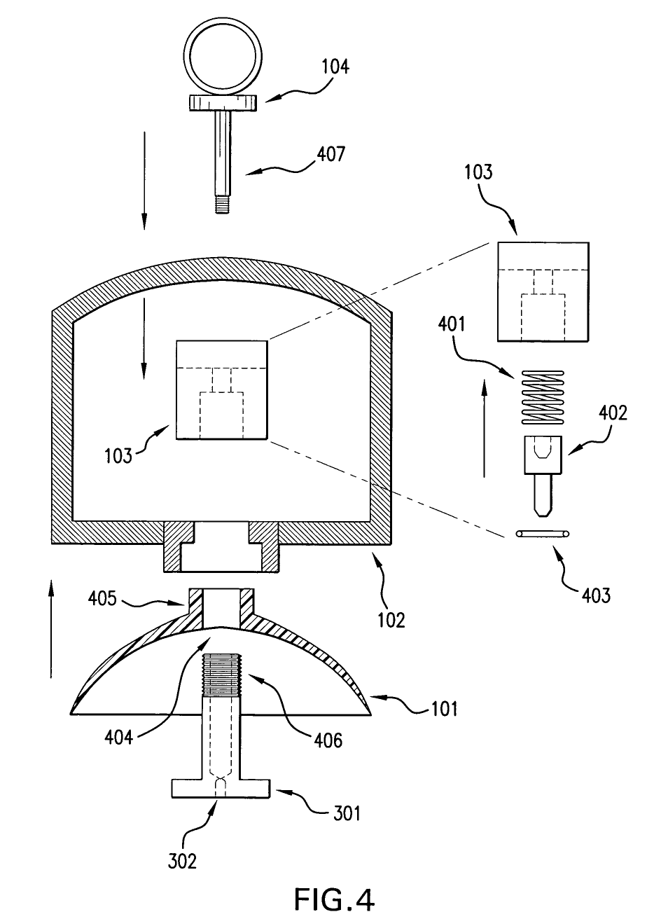

The various elements of the vacuum lifter of the present invention are depicted in FIGS. 1 through 5. A resilient suction cup (101), which is made from materials, such as for example, silicon, which can withstand high temperatures and be strong enough to support the objects to be transported can be employed. The suction cup has a bleed hole (404) in the hub (405). A threaded center piece (301) is tightly fitted inside the bleed hole (404) of the hub (405). The threaded center piece (301) is equipped with a bottom opening (302) which opens to the interior of the suction cup. A threaded portion of the threaded center piece (406) projects above the top of the hub. The threads are located on the outside upper section of the center piece (301). The threaded center piece (301) may be constructed of any material that can withstand the pH and temperature requirements previously mention. Suitable materials include, for example, 304, and 316 stainless steel.

The handle (102) comprises substantially u-shaped arms that are permanently affixed to a sleeve. The sleeve is of such dimension that it can readily and securely slip over the threaded portion of the threaded center piece (406). A lock nut (103) is applied to the threaded portion (406) and, when fully employed, the lock nut (103) rests flush with the contacting upper part of the sleeve that is part of the handle (102), thereby firmly securing the handle (102) to the hub (405). When engaged, the lock nut (103) and the threaded center piece (406) form a housing for the check valve assembly. Suitable materials of construction for the handle (102) and lock nut (103) include, for example, 304, and 316 stainless steel.

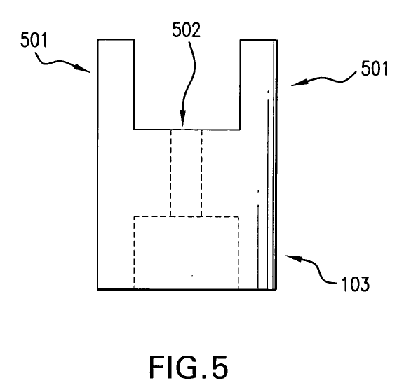

The lock nut (103) is roughly cylindrical in shape. At one end of the lock nut (103) a channel is carved out of the center of a cylinder, down the vertical axis leaving two wings (502) on the outer edges. The opposite end of the lock nut is machined to receive the threaded section of the center piece (301). See FIG. 5 for a cross sectional view of the lock nut (103). Additionally, the lock nut (103) has a hole (502) through which a stem (407) can be extended. On one end of the stem (407), a pull ring (104) is attached. The other end of stem is threaded.

Inside the housing formed by the lock nut (103) and the threaded center piece (301), the check valve assembly is found. The check valve assembly comprises a spring (401), a plunger (402), and an O-ring (403). The spring (401) is coiled about the stem (407) and sits between the lock nut (103) and the threaded end of the stem (407). The plunger (402) is fashioned in a way that it receives the threaded portion of the stem (407). Additionally, the plunger (402) is machined to mimic the contour of the interior of the bottom of the threaded center piece (301) where the bleed hole (302) is located. An O-ring (403) is placed between the plunger (402) and the bottom of the threaded center piece (406). The O-ring acts as a seal for the check valve assembly. The O-ring (403) is made from resilient material that can withstand the high temperature and chemical resistancy required. Examples of suitable O-ring materials include, but are not limited to, silicon, and KALREZ®, a perfluoroelastomer. Examples of suitable materials of construction for the plunger and spring include 304 and 316 stainless steel. These materials are FDA approved for the food and pharmaceutical industries.

When the vacuum lifter is ready for use, the pull ring (104) is positioned in channel between the wings (501) of the lock nut (103). This position, allows for the proper seating of the plunger (402) against the bleed hole (302) at the bottom of the threaded center piece (301) thus sealing the bleed hole (302). The vacuum lifter is then positioned, suction cup (101) side down, onto an object having at least one smooth, flat, non-porous surface. The suction cup (101) is then evacuated by applying downward pressure on the handle (102) thus depressing the resilient suction cup (101) and expelling air to produce a vacuum. The object can then be lifted and transported to the desired location. To release the vacuum lifter from the object, the pull ring (104) is lifted. To prepare the vacuum lifter for the autoclave and other disinfection protocols, the pull ring (104) is lifted from the channel of the lock nut (103), rotated 90° and allowed to rest on top of the wings (501) of the lock nut (103). In this manner, the bleed hole (302) at the bottom of the threaded center piece (301) remains open to the atmosphere. This allows steam to penetrate through the interior of the threaded center piece (301) during high temperature disinfection of the unit. In this manner, the interior parts of the vacuum lifter can be sterilized without totally disassembling the vacuum lifter.

Additionally, the vacuum lifter of the present invention is designed in such a manner as to make maintenance simple. The metal parts of the vacuum lifter are constructed from non-rusting material which can withstand harsh environments including high temperatures, and acidic and basic conditions. Replacement of the check valve assembly O-ring is accomplished by simply unscrewing the lock nut (103) from the threaded center piece (301) and removing and replacing the warn O-ring.

What is claimed is:

1. A vacuum lifter comprising:
a) a suction cup having a hub and an axial bleed hole in the hub,
b) a center-piece sleeve member molded in the hub and having threaded extensions above the and forming a continuation of the axial bleed hole,
c) a handle over the cup and above the center-piece sleeve member,
d) a lock-nut, threaded on the center-piece sleeve member and securing the handle to the cup and forming a chamber between the lock-nut and the sleeve member,
e) a means to establish communication between the chamber and the atmosphere,
d) a check valve assembly in the chamber between the bleed hole and the means, wherein the check valve assembly is operatively connected to the means and the check valve assembly normally closing the bleed hole and wherein the means is optionally capable of maintaining the check valve assembly and the bleed hole open.

2. A vacuum lifter of claim 1, wherein the vacuum assembly comprises an O-ring, a plunger, and a spring, wherein the means is operatively connected to the plunger.

3. A vacuum lifter of claim 2, wherein the means comprises a pull ring attached to a stem.

4. A vacuum lifter of claim 3, wherein the vacuum lifter is constructed from FDA approved materials.
